(19) United States
(12) Patent Application Publication
(10) Pub. No.: US 2024/0376566 A1
(43) Pub. Date: Nov. 14, 2024

(54) HYDROMETALLURGICAL TREATMENT OF ORES OR CONCENTRATES FOR REMOVAL OF PREG-ROBBING ORGANIC CARBON MATERIAL

(71) Applicant: HATCH LTD., Mississauga (CA)

(72) Inventors: Brady Haneman, Oakville (CA); Cinziana Sist, Etobicoke (CA); Mark Eichhorn, Oakville (CA)

(21) Appl. No.: 18/554,341

(22) PCT Filed: Apr. 12, 2022
(86) PCT No.: PCT/CA2022/050564

§ 371 Date: Oct. 6, 2023

Related U.S. Application Data
(60) Provisional application No. 63/173,803, filed on Apr. 12, 2021.

(51) Int. Cl. C22B 11/00; C22B 1/00; C22B 3/24; C22B 3/44

(52) U.S. Cl. CPC C22B 11/04; C22B 1/00; C22B 3/24; C22B 3/44

(57) ABSTRACT

A process for helping improve hydrometallurgical precious metal recovery from preg-robbing ores or concentrates, such as double refractory ores or concentrates or carbonaceous ores. The process comprises treating the ore or concentrate in the presence of oxygen at a temperature and pressure sufficient to oxidize at least a portion of the organic carbon material in the ore or concentrate. A vessel is used to treat the ore or concentrate to oxidize the organic carbon material. The vessel may be a pipe. The vessel maintains the ore at an elevated temperature and pressure in the presence of oxygen. The vessel may have an inlet for receiving a pre-treated slurry of ore or concentrate, a mechanism for oxygen addition, a mechanism for degassing the pipe reactor, and an outlet for providing the treated slurry to further processing. The vessel may be used in series after an autoclave. The pipe reactor may also include a pre-heating step and a cooling step.

### CROSS REFERENCE TO RELATED APPLICATION

This application claims priority to U.S. Provisional Patent Application number U.S. 63/173,803, filed Apr. 12, 2021, the entire contents of which are hereby incorporated by reference.

### FIELD

The present disclosure relates to hydrometallurgically processing preg-robbing ores or concentrations, including double refractory ores or ore concentrate.

### BACKGROUND

The recovery of precious metals from preg-robbing ores (including double refractory ores) is challenging due to the presence of sulfide minerals and/or organic carbon material in the ores. The sulfide minerals and/or organic carbon material inhibit separation of the precious metals from the unwanted materials (gangue). A preg-robbing ore typically refers to an ore containing precious metal and organic carbon material. A double refractory ore typically refers to an ore containing precious metal, organic carbon material, and sulfide minerals. Existing pyrometallurgical and/or hydrometallurgical treatment of double refractory ores, to mitigate the effect of organic materials in the ores, have drawbacks.

Pyrometallurgical treatment of organic carbon-bearing ore is typically accomplished using a roasting treatment step to thermally oxidize the organic carbon. The process is capital intensive, requiring off-gas handling systems to limit environmental emissions of toxic contaminants. For example, pyrometallurgical treatment of ore requires capturing sulfur dioxide, and results in the volatilization of arsenic present in the ore. Pyrometallurgical treatment may also have a lower rate of gold recovery than hydrometallurgical treatment of ore.

Treatments have incorporated the following types of processes to mitigate the effects of organic carbon material: conversion of Carbon-in-Pulp (CIP) to Carbon-in-Leach (CIL); the addition of binding agents such as kerosene; use of thiosulfate; chlorination processes; Pressure Oxidation (POX) circuits with high retention times; and fine grinding of feed material.

In a conventional hydrometallurgical process, a downstream treatment process may try to inhibit the ability of the organic carbon to interfere with precious metal adsorption (and therefore recovery) onto activated carbon. In this manner, the preg-robbing material interference with adsorption is impeded. An upstream treatment may include fine grinding feed material to help liberate and enhance oxidation kinetics of both the sulfide and organic carbon material.

### BRIEF DESCRIPTION OF THE FIGURES

Embodiments of the present disclosure will now be described, by way of example only, with reference to the attached Figures.

FIG. 1a and FIG. 1b are flow diagrams of the hybrid reactor system according to an embodiment of the present disclosure. FIG. 1c illustrates the interaction between FIG. 1a and FIG. 1b.

FIG. 2 is an end view of a pipe reactor according to an embodiment of the present disclosure.

FIG. 3 is a top view of the pipe reactor shown in FIG. 2.

### DETAILED DESCRIPTION

The present disclosure describes a hydrometallurgical treatment of an ore or concentrate containing precious metals and organic carbon material using an elevated temperature (and pressure) reactor system with oxygen to help recover the precious metals. The ore or concentrate may also contain sulfur or sulfides (e.g., sulfide minerals, sulfide materials, etc.). The reactor system may be a pipe reactor. The hydrometallurgical treatment may augment an existing pressure oxidation autoclave operation for helping recover precious metals from the ore or ore concentrate. In an embodiment, a hydrometallurgical process comprising a hybrid pipe reactor, in combination with existing pressure oxidation autoclave circuits as an integral series unit operation, may help enhance metal recovery from ores or concentrates comprising precious metals and organic carbon material; for example: enhancing metal recovery for preg-robbing ore (including double refractory ore) treatment and/or enhancing sulfide oxidation in single refractory material.

In accordance with an embodiment of the present disclosure, residual organic carbon material in a hydrometallurgical ore or ore concentrate slurry is thermally oxidized and rendered inert using high temperature and pressure. In accordance with this embodiment, residual sulfides may also be oxidized in a similar manner resulting in unlocking even further precious metal values. Such a hydrometallurgical treatment of the ore or concentrate may have one or more of the following benefits: (1) higher gold recovery; (2) sulfur dioxide capture from roasting is not required; and (3) for arsenic-containing ores or concentrates, the hydrometallurgical treatment with pressure oxidation may fix/stabilize the arsenic in the residue, as opposed to volatilizing it, as compared to a pyrometallurgical process, for example. This oxidation process may help increase or maximize the recovery of precious metals and/or render the material more amenable to conventional downstream metal recovery processes so that downstream operations may not require modification.

The use of a hybrid pipe reactor or a similar vessel, such as those herein described, to the tail end of the pressure oxidation process may help remove or render inert the preg-robbing material from the ore or concentrate. The use of a hybrid pipe reactor may help enhance the oxidation of the ore or concentrate beyond the capabilities of a pressure oxidation autoclave. The flow design of the hybrid pipe reactor may help improve oxidation kinetics of the organic carbon material and/or sulfide minerals in the ore, concentrate, or slurry. For example, the hybrid pipe reactor, at elevated temperature and pressure, may achieve greater oxidation of organic carbon material and/or sulfide minerals in a significantly reduced duration as compared to larger continuous or batch vessels, such as an autoclave. A potential benefit from the use of a hybrid reactor may be that the kinetics of the chemical oxidation reaction of the organic carbon are accelerated at elevated temperatures. Other potential benefits may be due to the use of the pipe reactor, itself.

In one or more embodiments, the pipe reactor provides plug flow reaction kinetics, unlike the continuous stirred tank reactor system of a multi-chamber autoclave. The plug flow reactor may require a lower residence time for the ore or ore concentrate than that required by the multi-chamber agitated vessel to achieve the same reaction conversion extent. Furthermore, the reactor wall thickness (which resists internal pressure) is directly proportional to its diameter. Therefore, the hybrid pipe reactor may operate at an elevated pressure and temperature with a wall thickness that is less than a wall thickness that would be required for a vessel of a larger diameter (such as an autoclave) operating at a similar temperature and pressure. It may be impractical for such larger diameter vessels (e.g. an autoclave) to have such wall thicknesses, however.

Autoclaves typically comprise rotating mechanical components, such as agitators, which may be less able to robustly withstand the high temperatures and pressures required to oxidize organic material in a preg-robbing (including double refractory) ore or concentrate, especially under acidic or alkaline conditions. For example, such rotating mechanical components are subject to wear over time, and may degrade more quickly under the high temperatures and pressures required to oxidize organic material in a preg-robbing (including a double refractory) ore or concentrate. Furthermore retrofitting an existing process, such as a conventional pressure oxidation or autoclave process, with a hybrid pipe reactor may be less effort than replacing an autoclave. The hybrid pipe reactor design may be more beneficial than other reactor designs by eliminating the amount and/or complexity of the rotating and stationary mechanical parts required. A hybrid pipe reactor may increase the residence time capacity of an existing facility with which it is integrated, or as compared to conventional pressure oxidation reactors. Resulting from such reduced mechanical complexity, it is expected that the hybrid pipe reactor may be less expensive to build and/or operate as compared to other pressure oxidation reactors.

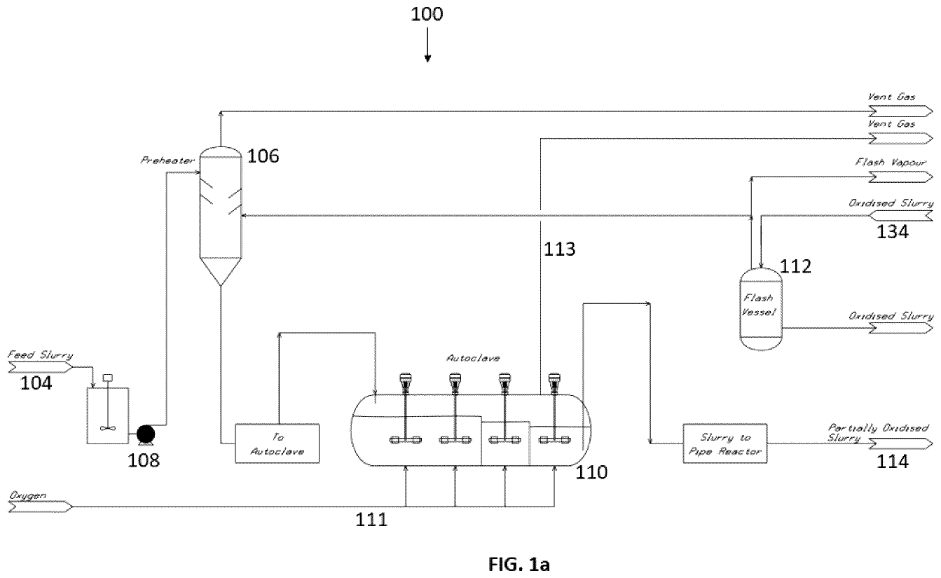

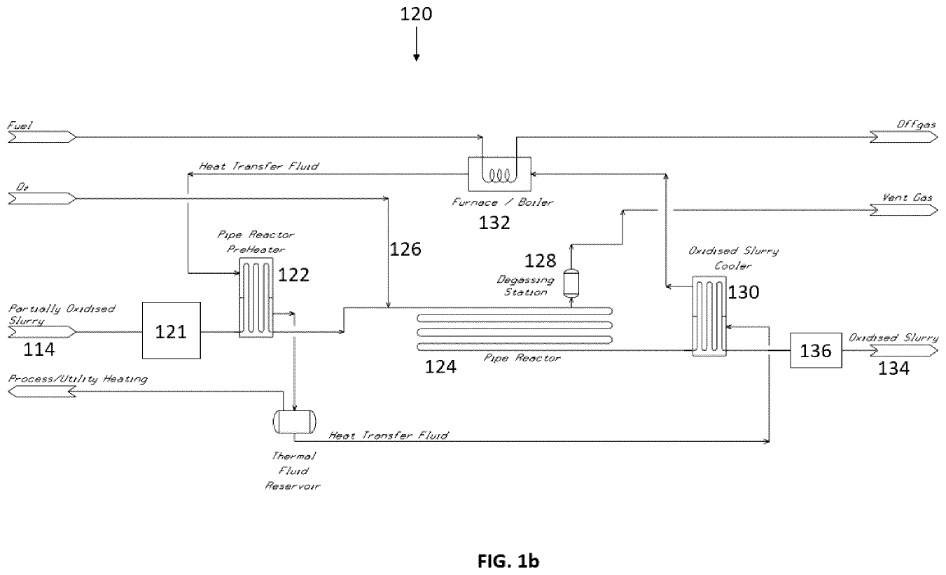

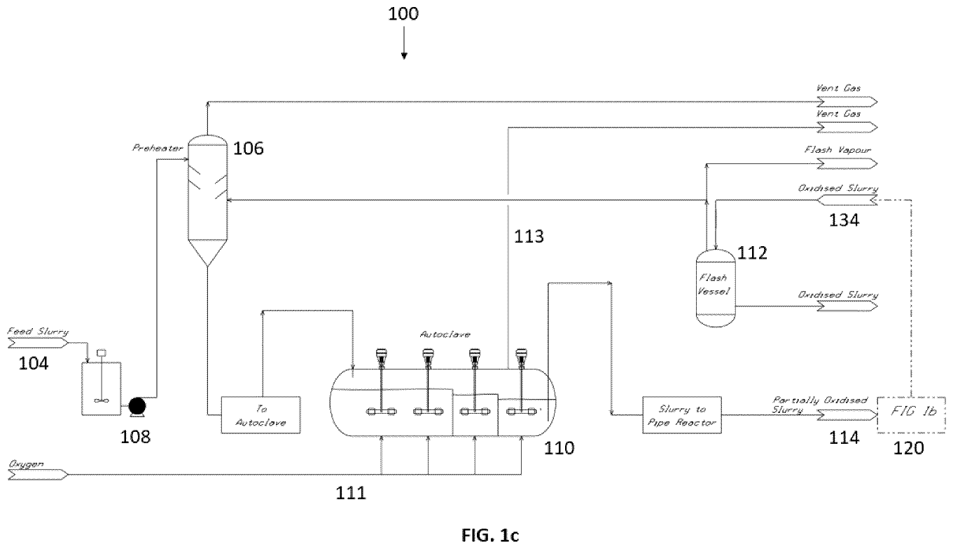

In one or more embodiments, there is provided a hybrid reactor configured to hydrometallurgically treat ore or concentrate comprising precious metal and organic carbon material, such as carbonaceous and/or double refractory ores, using an elevated temperature (and pressure) pipe reactor in an oxygen rich environment, such as the pressure oxidation hybrid reactor shown in FIG. 1a and FIG. 1b. The conduit of the pipe reactors may have a tubular shape. The hybrid reactor may be part of an ore processing facility. As shown in FIG. 1a and FIG. 1b, the hybrid reactor comprises an autoclave circuit followed by a pipe reactor. The pipe reactor may be in series, downstream of the pressure oxidation autoclave circuit. The pipe reactor may augment the tail end of an existing pressure oxidation autoclave facility initially designed for the pre-treatment of single refractory ores but subsequently treating double refractory ores. The pipe reactor may augment the tail end of an existing pressure oxidation autoclave facility initially designed for removing sulfides. In oxidizing the organic carbon material in the pipe reactor, preferential precious metal adsorption to the organic carbon in lieu of the activated carbon in a downstream CIL/CIP may be significantly reduced or altogether eliminated, increasing overall precious metal recovery.

FIGS. 1a-c collectively show process flow diagrams of a hydrometallurgical treatment process comprising a hybrid reactor (system 100 and system 120) according to an embodiment of the present disclosure. In FIG. 1a, a feed slurry 104 comprising ore or ore concentrate is passed through a preheater 106 using feed pumps 108 and fed into an autoclave 110. Alternatively, the ore or concentrate slurry 104 can be fed to the autoclave 110 directly using pumps 108. The autoclave 110 may be operating in the range 180-235° C. The autoclave 110 may include one or more inlets 111 for oxygen, and one or more outlets 113 for vent gas. The hybrid reactor system 100 according to one or more embodiments of the present disclosure may bypass a flash vessel, or operate in a loop to further treat the slurry and return the treated slurry to a flash vessel 112. The partially oxidized slurry 114 exiting the autoclave 110 in one or more outlets is fed into a pipe reactor system 120, as shown in FIG. 1b.

FIG. 1b shows that the pipe reactor system 120 comprises a pressurizing step to boost the pressure of the stream to sufficient levels to feed the pipe reactor system and achieve the desired operating pressure. The pressurizing step may include pumps or a pumping system. The slurry is directed to a pre-heating system 122 employing heat transfer to the precious metal bearing slurry. Such pre-heating system 122 may increase the temperature of the partially oxidized slurry 114 exiting an autoclave 110 from ˜180-235° C. to ˜250-300; or from about 180-245° C. to about 270-320° C. The pre-heating system 122 may employ one or more methods of indirectly or directly transferring heat to the feed slurry entering the pipe reactor 124. Indirect methods may include, for example, the use of heat transfer fluids such as oils or molten salts, aqueous solutions, or the use of steam. Direct heat transfer methods may include, for example, the application of a contact heater whereby high-pressure steam is injected directly into the slurry exiting the autoclave. The pre-heated and partially oxidized slurry is transferred to the pipe reactor 124. The pipe reactor 124 operates at elevated pressure and temperature and provides an oxygen rich environment to help thermally oxidize carbonaceous matter present in the ore slurry, resulting in reduction or elimination of preg-robbing adsorptive losses in a downstream CIL/CIP circuit. The pipe reactor 124 comprises one or more inlets 126 for oxygen, and one or more outlets 128 for vent gas. Following the pipe reactor 124 may be a slurry cooling system 130 such as a subcooling heat exchanger employing indirect heat transfer. A subcooling heat exchanger 130 may be coupled to a furnace or boiler 132 for reheating the heat transfer fluid for use in the pre-heating system 122. The reactor system 120 also comprises a pressurizer 136. The pressurizer helps maintain the pressure of the slurry in the pipe reactor 124. The subcooled and oxidized slurry 134 may then be directed to one or more flash vessels (that may be pre-existing or installed as part of the hybrid reactor system), such as flash vessel 112 of FIG. 1a, to depressurize the slurry to atmospheric saturation point for further processing. For example, FIG. 1c shows an embodiment of a hybrid pipe reactor system 100 similar to that of FIG. 1a, where the partially oxidized slurry 114 exiting the autoclave 110 is transferred to a pipe reactor system 120. The oxidized slurry 134 exiting the pipe reactor 124 may be fed to flash vessel 112.

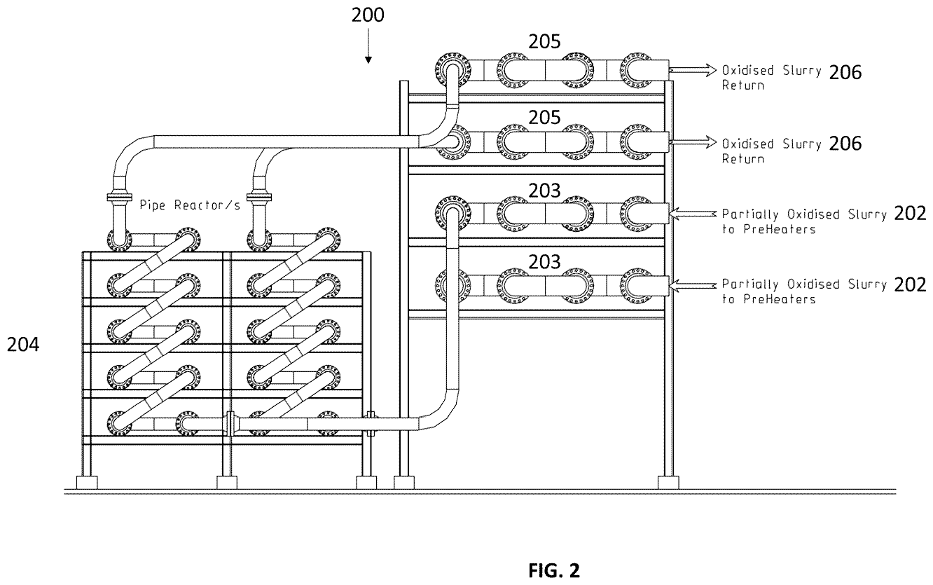

FIG. 2 shows an end view of an embodiment of a pipe reactor system 200. The pipe reactor system 200 may be for use in a hydrometallurgical treatment process comprising a hybrid reactor system. For example, the pipe reactor 200 system shown in FIG. 2 may correspond with the pipe reactor 120 of FIG. 1b. The pipe reactor system 200 comprises a pipe reactor 204. As shown in FIG. 2, partially oxidized slurry 202 may be transferred to the pipe reactor 204; for example, the partially oxidized slurry 202 may be received from a pre-treatment pressure oxidation process. The partially oxidized slurry 202 may be transferred to the pipe reactor 204 after first being transferred to and passing through pipe reactor preheaters 203. For example, the pipe reactor preheaters 203 shown in FIG. 2 may correspond to the pre-heating system 122 of FIG. 1b. The partially oxidized slurry 202 may be treated in the pipe reactor(s) 204 at increased temperature and pressure in the presence of oxygen. The resultant oxidized slurry 206 may then be transferred for further processing. The resultant oxidized slurry 206 emerging from the pipe reactor 204 may be transferred for further processing after being first transferred to and passing through pipe reactor subcoolers 205. For example, the pipe reactor subcoolers 205 shown in FIG. 2 may correspond to the slurry cooling system 130 of FIG. 1b.

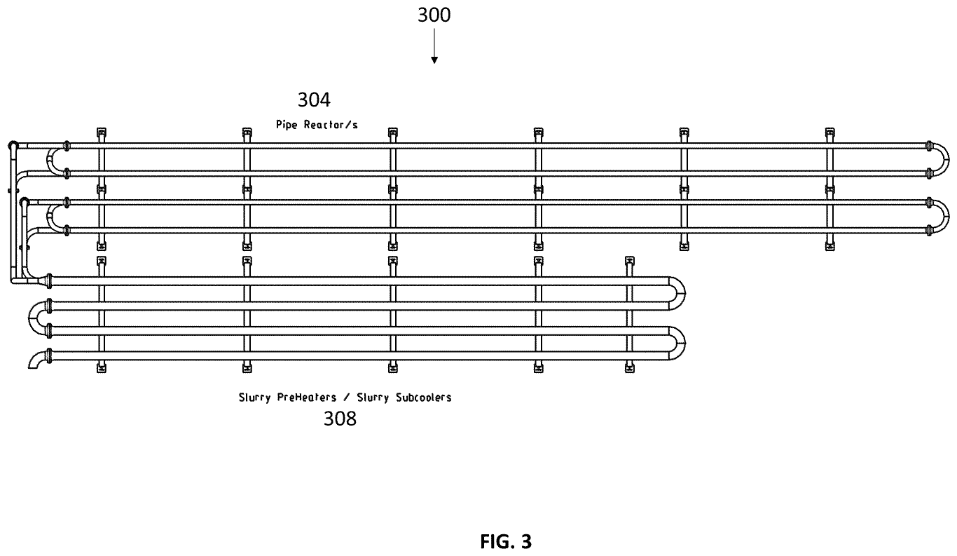

FIG. 3 shows a top view of a pipe reactor 300 system similar to the pipe reactor system 200 shown in FIG. 2, where the pipe reactor(s) 304 is coupled to slurry preheaters and/or slurry subcoolers 308. The slurry preheaters/slurry subcoolers 308 shown in FIG. 3 correspond to the pipe reactor preheaters 203 and/or the pipe reactor subcoolers 205 shown in FIG. 2.

In an embodiment, the present disclosure provides a process for treating ore or concentrate comprising precious metal and organic carbon material, such as a preg-robbing (including double refractory) ore or concentrate, the process comprising: receiving the ore or concentrate; and treating the ore or concentrate in the presence of oxygen at a temperature and a pressure sufficient to oxidize at least a portion of the organic carbon material.

Treating the ore or concentrate to oxidize at least a portion of the organic carbon material may occur in a pressure vessel. The pressure vessel may be an autoclave. The pressure vessel may be any suitable means of pressurizing the ore or concentrate at elevated temperatures. The pressure vessel may be a pipe or pipe reactor. Treating the ore or concentrate in a pressure vessel may comprise treating the ore or concentrate in a pipe reactor.

The process may further comprise a pre-treatment step or pre-treating the ore or concentrate. Pre-treating may include mechanical, physical, or chemical processing of the ore or concentrate. Mechanical pre-treating, for example, may include fine grinding the feed material to help liberate and enhance oxidation kinetics of both the sulfide and organic carbon material. The process may further comprise pre-treating the ore or concentrate at an elevated temperature and pressure, such as a temperature of about 25 to about 270° C., and/or a pressure of about 1 to about 60 atm. The process may further comprise pre-treating the ore or concentrate in a pressure oxidation autoclave.

The pressure oxidation autoclave treatment may occur at a temperature of about 180° C. to about 270° C., about 180° C. to about 250° C., or about 180° C. to about 245° C., or about 180° C. to about 240° C., or about 180° C. to about 235° C., such as about 180° C. to about 190° C., or about 180° C. to about 200° C., or about 190° C. to about 200° C., or about 200° C. to about 210° C., or about 190° C. to about 210° C., or about 200° C. to about 210° C., or about 200° C. to about 220° C., or about 210° C. to about 220° C., or about 210° C. to about 230° C., or about 220° C. to about 230° C., or about 220° C. to about 240° C., or about 230° C. to about 240° C., or about 230° C. to about 245° C., or about 240° C. to about 250° C., or about 250° C. to about 260° C., or about 250° C. to about 270° C.; or about 180° C., about 185° C., about 190° C., about 195° C., about 200° C., about 205° C., about 210° C., about 215° C., about 220° C., about 225° C., about 230° C., or about 235° C., or about 240° C., or about 245° C., or about 250° C., or about 255° C., or about 260° C., or about 265° C., or about 270° C.; or at a temperature, or any range of temperatures between about 180° C. and about 270° C.

The pressure oxidation autoclave treatment may occur at a pressure of about 10 to about 60 atm, or about 13 to about 52 atm, or about 13 to about 33 atm, such as about 13-15 atm, about 13-18 atm, about 15-18 atm, about 15-20 atm, about 13-20 atm, about 15-25 atm, about 20-25 atm, about 20-30 atm, about 25-30 atm, about 25-33 atm, or about 30-33 atm, or about 30-35 atm, or about 30-40 atm, or about 35-40 atm, or about 35-45 atm, or about 40-45 atm, or about 40-50 atm, or about 50-52 atm, or about 50-60 atm, or about 13 atm, about 15 atm, about 20 atm, about 25 atm, about 30 atm, or about 33 atm, or about 35 atm, or about 40 atm, or about 45 atm, or about 50 atm, or about 52 atm, or about 60 atm, or at a pressure, or any range of pressures between about 10 atm and about 60 atm. It will be understood that pre-treating the ore or concentrate in a pressure oxidation autoclave may include the use of an autoclave or vessel capable of operating outside the conventional conditions. An autoclave capable of operating above about 235° C., or about 245° C., or about 250° C., or about 270° C., and/or above about 33 atm or about 52 atm, or about 60 atm may be used in the process. The pre-treatment may occur at a temperature of about 25 to about 270° C. The pre-treatment may occur at a pressure of about 1 to about 57 atm.

Receiving the ore or concentrate may comprise receiving a pre-treated slurry of the ore or concentrate. Receiving the ore or concentrate may comprise receiving a slurry of the ore or concentrate exiting a pressure oxidation autoclave treatment. Receiving the ore or concentrate may comprise receiving a slurry of the ore or concentrate exiting a pre-heating apparatus. Receiving the ore or concentrate may comprise receiving crude ore, and the process further comprises pre-treating the ore to form a slurry to be treated to oxidize at least a portion of the organic carbon material.

Treating the ore or concentrate may comprise one or more of the following: heating the slurry; transferring the slurry through a pipe reactor; adding oxygen to the slurry in the pipe reactor; maintaining the slurry, for a select duration, at the temperature and pressure sufficient to oxidize at least a portion of the organic carbon material; cooling the slurry; and depressurizing the slurry. The slurry may be further processed to recover the precious metal.

The ore or concentrate may be treated in the presence of oxygen at a temperature and a pressure sufficient to oxidize at least a portion of the organic carbon material. The slurry may be heated to a temperature of about 250 to about 320° C., or about 250 to about 300° C., or about 270 to about 320° C., about 270 to about 300° C. to oxidize at least a portion of the organic carbon material. The slurry may be heated to a temperature of about 250 to about 260° C., about 250 to about 275° C., about 260 to about 270° C., about 260 to about 280° C., about 270 to about 290° C., about 270 to about 300° C., about 275 to about 300° C., about 280 to about 290° C., or about 290 to about 300° C., about 300 to about 310° C., about 300 to about 320° C., or about 310 to about 320° C., or about 250° C., about 260° C., about 270° C., about 275° C., about 280° C., about 290° C., or about 300° C., or about 310° C., or about 320° C., or at a temperature, or any range of temperatures between about 250° C. and about 320° C. The temperature may be sufficient to oxidize at least 25%, at least 50%, at least 75%, at least 90%, at least 95%, at least 99%, or substantially all of the organic carbon material. The temperature may be sufficient to oxidize at least a portion of the organic carbon material when in combination with a suitable pressure (and vice versa).

The slurry may be pressurized to a pressure of about 50 to about 107 atm, or about 50 to about 120 atm, or about 58 to about 120 atm to oxidize at least a portion of the organic carbon material. The slurry may be pressurized to a pressure of about 50 to about 60 atm, about 50 to about 75 atm, about 50 to about 100 atm, about 58 to about 120 atm about 60 to about 80 atm, about 80 to about 100 atm, about 60 to about 70 atm, about 70 to about 80 atm, about 70 to about 90 atm, about 70 to about 100 atm, about 70 to about 110 atm, about 60 to about 90 atm, about 75 to about 100 atm, about 75 to about 120 atm, about 80 to about 90 atm, about 90 to about 100 atm, about 90 to about 110 atm, about 90 to about 120 atm, about 100 to about 105 atm, or about 100 to about 107 atm, about 100 to about 110 atm, about 100 to about 120 atm, or about 50 atm, about 60 atm, about 70 atm, about 80 atm, about 90 atm, about 100 atm, about 105 atm, or about 107 atm, or about 110 atm, or about 120 atm; or at a pressure, or any range of pressures between about 50 atm and about 120 atm. The pressure may be sufficient to oxidize at least 25%, at least 50%, at least 75%, at least 90%, at least 95%, at least 99%, or substantially all of the organic carbon material. The pressure and temperature may be sufficient to oxidize at least a portion of the organic carbon material when maintained for a select duration. The select duration may be about 5 min. The select duration may be in the range of about 5 min to about 30 min or about 5 min to about 45 min, or about 5 min to about 60 min. The select duration may be greater than 60 min. The selected duration may be about 5 to about 10 min, about 10 to about 15 min, about 15 to about 20 min, about 20 to about 25 min, about 25 to about 30 min, about 30 to about 35 min, about 35 to about 40 min, about 40 to about 45 min, about 45 to about 50 min, about 50 to about 55 min, about 55 to about 60 min, or >60 min; or about 5 to about 15 min, about 10 to about 20 min, about 15 to about 30 min, or about 20 to about 30 min, about 30 to about 45 min, about 45 to about 60 min, about 30 to about 60 min, about 40 to about 50 min, about 50 to about 60 min, or >60 min; or about 5 min, about 10 min, about 15 min, about 20 min, about 25 min, or about 30 min, or about 35 min, or about 40 min, or about 45 min, or about 50 min, or about 55 min, or about 60 min, or >60 min; or a time, or any range of times between about 5 min and about 60 min. The temperature and pressure may be constant for the entire duration, or the temperature and/or pressure may be variable.

The process may further comprise a precious metal recovery step. The process may further comprise recovering at least a portion of the precious metal from the ore or concentrate after oxidizing at least a portion of the organic material. The precious metal recovery step may be any suitable means of recovering precious metals, such as recovering precious metals in a slurry or solution. Improving precious metal recovery may comprise improving the quantity, quality, or type of precious metal recovered, as compared to the quantity, quality, or type of precious metal recovered using other processes or methods, such as ultrafine grinding, biological oxidation, oxidative leaching at atmospheric pressure, roasting, conventional POX, cyanidation and thiosulphate leaching, or a combination thereof. Improving precious metal recovery may comprise an increase in the amount of precious metal recovered from a given ore, as compared to treatment of said ore using other methods. Improving precious metal recovery may also comprise using ore or concentrate treated from another process for additional precious metal recovery by one or more of the processes described herein. Precious metal recovery may be carried out using any suitable means, method, or process. Recovering the portion of the precious metal may comprise a precipitation process. The precipitation may be a cementation process. Recovering a portion of the precious metal may comprise an adsorption process. The adsorption process may comprise adsorption of the precious metal onto activated carbon. The adsorption process may involve adsorption onto any suitable material, such as activated carbon or a resin.

Oxidizing at least a portion of the organic carbon material in the ore or concentrate may increase precious metal recovery by reducing or eliminating organic carbon material that would otherwise impede adsorption. Treating the ore or concentrate may increase the affinity of the precious metal to the activated carbon. The affinity of the precious metal to the activated carbon may result from the fact that the process according to one or more embodiments of the present disclosure effectively oxidizes the organic carbon in the ore or concentrate to CO/CO₂ or other compounds, thereby reducing or eliminating it.

The precious minerals (including metal) may be any one or a combination of naturally occurring chemical elements or compounds. The precious metal may be gold. The precious metal may be silver. The precious metal may be gold and silver. The precious metal may be any one or a combination of gold, silver and the platinum group metals such as ruthenium, rhodium, palladium, osmium, iridium and platinum.

The ore or concentrate may comprise precious metal and organic carbon material. The ore or concentrate may be a preg-robbing ore or concentrate. Preg-robbing ore or concentrate may comprise organic carbon material or carbonaceous material, while being substantially free, or free of sulfur or sulfides (e.g., sulfide minerals, sulfide materials, etc.). The ore or concentrate may be a refractory ore, such as a single or double refractory ore. A double refractory ore or concentrate may comprise sulfur or sulfides (e.g., sulfide minerals, sulfide materials, etc., which tend to be considered refractory but not preg-robbing), as well as organic carbon materials or carbonaceous materials (with such carbon material tending to be considered preg-robbing). The ore or concentrate may be a sulfide mineral ore. The ore or concentrate may be a sulfide mineral containing carbonaceous matter. The ore or concentrate may be a sulfide mineral containing inorganic carbon matter such as carbonates. The ore or concentrate may be a sulfide mineral that contains both organic and inorganic carbon compounds. The ore or concentrate may contain precious metals, organic and/or inorganic carbon material, and sulfide minerals. The ore or concentrate may contain other metals, such as copper, nickel, or zinc. The ore or concentrate may contain sulfide minerals and sulfur. The ore or concentrate may contain sulfide minerals and sulfur and at least a portion of the sulfide minerals and sulfur may be oxidized in the treating or pre-treatment step. The ore or concentrate may, for example, include a gold and organic carbon bearing nickel laterite ore.

The process may comprise oxidizing at least a portion of the sulfide minerals and sulfur in the ore or concentrate or slurry during treating or pre-treatment step, such as a pressure oxidation autoclave treatment. If the ore or concentrate or slurry contains sulfide minerals and sulfur, and said ore or concentrate or slurry is being treated in the presence of oxygen at a temperature and a pressure sufficient to oxidize at least a portion of the organic carbon material, then said temperature and pressure may be sufficient to oxidize at least a portion of the sulfur. Removing at least a portion of the sulfide minerals and/or sulfur in the ore or concentrate or slurry via the pressure oxidation autoclave treatment may reduce the concentration, pressure, and/or flow of oxygen needed during the pipe reactor treatment. An autoclave may be operated at a temperature and pressure suitable for oxidation of sulfide minerals and/or sulfur in the ore, concentrate, or slurry. However, an autoclave may be incapable at operating at sufficiently high temperatures and pressures to oxidize all of an organic carbon material contained within the ore, concentrate, or slurry. For example, the seals of a convention autoclave may not be able to withstand the higher temperature and pressured required for oxidation of organic carbon material Utilization of a two-stage oxidation process as described herein (e.g., combination of POX autoclave and pipe reactor) may enable the pipe reactor to primarily target oxidation of the organic carbon. By removing at least a portion of the sulfide minerals and/or sulfur in the ore or concentrate or slurry using the pressure oxidation autoclave, less oxygen may need to be introduced into the pipe reactor to affect oxidation of the organic carbon material and remaining sulfide/sulfur materials within the pipe reactor. It is desirable to minimize the amount of oxygen that needs to be provided to the pipe reactor due to challenges associated with gas handling in the pipe reactor. For example, it may be possible to mitigate or entirely avoid the formation of a complex three-phase non-newtonian fluid flow behaviour which may otherwise occur if there was significant oxygen addition and/or vent gas generation in the pipe reactor. If three-phase fluid flow occurs in the pipe reactor, it may interfere with the performance of the pipe reactor by hindering its residence time, reaction kinetics, and/or thermohydraulic performance.

In an embodiment, the present disclosure provides a reactor system for treating a ore or concentrate comprising precious metal and organic carbon material, such as a preg-robbing (including double refractory) ore or concentrate, the reactor system comprising: an inlet for receiving an untreated slurry of the ore or concentrate; a vessel having a first end with the inlet, an oxygen injector, and a degasser; a heater for elevating the temperature of the slurry in the vessel; a pressurizer for maintaining the slurry pressure; and an outlet at a second end of the vessel, the outlet for providing the treated slurry for further processing.

The reactor system may be a pipe or pipe reactor. The reactor system may be coupled to an autoclave. The reactor system may be used in the recovery of precious metals from ores or concentrates comprising precious metal and organic carbon material, such as a preg-robbing (including double refractory) ore or concentrate. The reactor system may be used in the recovery of precious metals from ores or concentrates containing precious metals, or double refractory ores. The reactor system may be any suitable vessel for the indicated purpose, such as for oxidizing at least a portion of the carbon material in an ore or concentrate. Any suitable size or shape of reactor may be used in the reactor system, such as a pipe reactor or pipe reactor that may be generally elongated in length. A hybrid pipe reactor may refer to a system in which a pipe reactor is coupled to another pressure oxidation system, such as an autoclave. The reactor system may comprise a length of a pipe reactor having a first end coupled to an inlet for receiving the ore or concentrate, and a second end coupled to an outlet for providing the treated slurry for further processing.

In use, the reactor system is for treating the ore, concentrate, or slurry thereof, with an elevated temperature and pressure in the presence of oxygen. Therefore, the reactor system may be configured to supply oxygen and/or degas as required, as well as to control the temperature and pressure. The reactor system may be coupled to a mechanism for oxygen addition. Referring again to FIG. 1b, the reactor system may be coupled to a mechanism for degassing the reactor such as a degasser 128. The reactor system may also include a transfer system 121 for transferring the slurry from the autoclave 110 through the vessel, such as through the length of a pipe reactor. The transfer system 121 may be any suitable system for transferring the slurry, such as a pump or pumping system. The reactor system may include a transfer system for transferring the slurry through the vessel and/or a system for transferring the slurry from an autoclave, or other pre-treatment apparatus, to the reactor vessel. The slurry may be transferred directly from an autoclave to the reactor vessel. The slurry may be transferred indirectly from an autoclave to the reactor vessel. The slurry may undergo further processing steps, such as after exiting an autoclave and before being transferred to the reactor vessel.

The reactor system may have an inlet for receiving a pre-treated slurry of the ore or concentrate. The inlet may be integral with the length of pipe reactor, and/or the inlet may comprise other components. The inlet may be coupled to, or a part of, a pre-heating apparatus, such as pipe reactor preheater 122 in FIG. 1b. The pre-heating apparatus may be for pre-heating the slurry, such as heating the slurry from the temperature of an autoclave to the temperature of the pipe reactor. The pre-heating apparatus may be an autoclave. The pre-heating apparatus may be any suitable means of heating, such as a heat exchanger. The pre-heating apparatus may be coupled to a cooling apparatus elsewhere, such as cooling apparatus 130 in FIG. 1b, for transferring heat from the treated slurry back to the pre-heating apparatus. The inlet or the pre-heating apparatus may be coupled to or integral with a pressurizer. Therefore, the temperature and/or the pressure of the pre-treated slurry may be augmented prior to treating the ore in the reactor system.

The reactor system may have an outlet for providing the treated slurry for further processing. The outlet may be integral with the length of pipe reactor, and/or the outlet may comprise other components. The outlet may be coupled to, or a part of, a heat exchanger or cooling apparatus. The cooling apparatus 130 may be for cooling the treated slurry, such as cooling the slurry from the temperature of the pipe reactor to a lower temperature. The reactor system may further comprise a flash vessel and the outlet may be coupled to the flash vessel for depressurizing the treated slurry. The outlet may be coupled, directly or indirectly, to apparatus for further treating the slurry, such as for precious metal recovery. The reactor system may further comprise a heat exchanger to transfer heat from the treated slurry to the untreated slurry.

The reactor vessel may be a length of pipe, or a reactor or containment vessel generally elongated in shape. The pipe reactor may be any size and shape suitable for treating the slurry at an elevated temperature and pressure in the presence of oxygen. The pipe reactor may have one elongated length of pipe reactor. The pipe reactor may include more than one discrete length of elongated pipe reactor

The pipe reactor may have a length of about 500 to about 1000 m, about 500 to about 3000 m, such as about 500 to about 600 m, about 600 to about 700 m, about 700 to about 800 m, about 800 to about 900 m, about 900 to about 1000 m, about 1000 to about 1500 m, about 1500 to about 2000 m, about 2000 to about 2500 m, about 2500 to about 3000 m, about 500 to about 750 m, or about 750 to about 1000 m, or about 500 to about 1500 m, or about 1500 to about 3000 m, or about 500 m, about 600 m, about 700 m, about 800 m, about 900 m, or about 1000 m, or about 1250 m, or about 1500 m, or about 1750 m, or about 2000 m, or about 2250 m, or about 2500 m, or about 2750, or about 3000 m; or at a length, or any range of lengths between about 500 m to about 3000 m.

The pipe reactor may extend in a winding arrangement to reduce the footprint of the hybrid pipe reactor. The pipe reactor may have a constant width, or the width of the pipe reactor may vary. The total overall width of the pipe reactor in a stacked and/or coiled arrangement may be any suitable width, such as between about 1 to about 10 m, or about 2 to about 10 m, or greater than 10 m. The pipe reactor width may be about 1 m, about 2 m, about 3 m, about 4 m, about 5 m, about 6 m, about 7 m, about 8 m, about 9 m, or about 10 m, such as about 1 to about 2 m, about 1 to about 3 m, about 1 to about 4 m, about 1 to about 4 m, about 2 to about 3 m, about 2 to about 4 m, about 2 to about 6 m, about 3 to about 5 m, about 4 to about 6 m, about 5 to about 7 m, about 6 to about 8 m, about 7 to about 9 m, about 8 to about 10 m, about 3 to about 7 m, about 4 to about 8 m, about 5 to about 8 m, about 5 to about 10 m, or about 6 to about 9 m; or at a width, or any range of widths between about 1 m to about 10 m.

The pipe or tube of the pipe reactor may be any suitable diameter, such as in the range of from about 25 to about 500 mm. The pipe or tube of the pipe reactor diameter may be about 25 mm, about 50 mm, about 75 mm, about 100 mm, about 200 mm, about 250 mm, about 300 mm, about 400 mm, or about 500 mm, or about 25 to about 50 mm, about 25 to about 75 mm, about 50 to about 100 mm, about 50 to about 200 mm, about 75 to about 100 mm, about 100 to about 200 mm, about 200 to about 300 mm, about 300 to about 400 mm, about 400 to about 500 mm, about 100 to about 300 mm, about 200 to about 400 mm, about 200 to about 500 mm, or about 250 to about 500 mm; or at a diameter, or any range of diameters between about 25 mm and about 500 mm.

The pipe reactor may be arranged so as from the point of oxygen addition, the reactor is either horizontal or continuously rising. The pipe reactor may comprise a single pass or have several passes that run forward and backward and run substantially horizontally, substantially vertically or any combination of horizontal and vertical configurations. An exemplary configuration is shown in FIGS. 2 and 3.

In an embodiment, the present disclosure provides a method of increasing recovery of precious metal from an ore or concentrate comprising or containing precious metal, sulfide minerals, and organic carbon material, the method comprising hydrometallurgical treatment of the ore or concentrate using an elevated temperature and pressure hybrid pipe reactor, in the presence of oxygen, to increase precious metal recovery.

In an embodiment, the present disclosure provides a hybrid pipe reactor system comprising a pipe reactor according to one or more embodiments coupled to an autoclave.

In an embodiment, the present disclosure provides a system for recovering precious metal from an ore or concentrate containing precious metal and organic carbon material, such as a preg-robbing (including double refractory) ore or concentrate, the system comprising: an autoclave; a pipe reactor for treating the slurry at elevated temperature and pressure in the presence of oxygen to oxidize at least a portion of the carbon material; and an apparatus for precipitating or adsorbing the precious metal from the treated slurry.

To gain a better understanding of the invention described herein, the following examples are set forth. It should be understood that these examples are for illustrative purposes only. Therefore, they should not limit the scope of this invention in anyway.

### EXAMPLES

### Example 1

A double refractory gold ore was processed in a batch autoclave as follows to simulate the hybrid reactor process as described herein.

### General Method and Material

450 grams of ore was ground to a P₈₀ of 15-20 micron particle size, and acidulated to approximately a pH of 2 to remove excess inorganic carbonates from the feed. The untreated feed material was composed of 2.36 wt % sulphide, 1.21 wt % total organic carbon (TOC), and 4.22 g/t Au. The acidulated feed was treated in a batch autoclave at an initial pulp density of approximately 30 wt % solids for 45 minutes at 225° C., with an oxygen overpressure of 7 atm to remove a majority of the 2.36 wt % sulphide in the feed material.

At the end of the pressure oxidation (POX) autoclave at 225° C., the oxygen was bled out of the vessel and the contents of the batch autoclave temperature was increased to 280° C. Oxygen was reintroduced to the vessel to simulate the pipe reactor operating at 10.3 atm oxygen overpressure for 10, 20, or 30 additional minutes.

### Results and Discussion

Samples were obtained at 45 minutes operating at POX autoclave (225° C., 7 atm O₂), at 10 minutes operating at pipe reactor conditions (280° C., 10.3 atm O₂), at 20 minutes operating at pipe reactor conditions, and at 30 minutes operating at pipe reactor conditions. Gold recovery at 45 min POX was measured at 60%. At 10 min of additional processing at pipe reactor conditions, Au recovery increased to 82%; at 20 min, Au recovery increased to 85%; and at 30 min, Au recovery increased to 92%. Gold was recovered using a bulk leach extractable gold (BLEG) method, involving leaching in cyanide solution and then assaying the solution to measure the amount of gold that was leached.

In a duplicate test, gold recovery at 45 min POX autoclave was measured at 51%. At 10 min of additional processing at pipe reactor conditions, Au recovery increased to 65%; at 20 min, Au recovery increased to 83%; and at 30 min, Au recovery increased to 94%.

As used in the specification and claims, the singular forms “a”, “an” and “the” include plural references unless the context clearly dictates otherwise. The term “comprising” as used herein will be understood to mean that the list following that term is non-exhaustive and may or may not include any other additional suitable items, for example one or more further feature(s), component(s) and/or ingredient(s) as appropriate.

As used herein, “oxidizing” or “oxidizing the organic carbon material” may refer to any process that oxidatively modifies or eliminates carbon material from an ore, concentrate, or slurry, such as the oxidation of the organic carbon material to form CO, CO₂, and/or other compounds.

A slurry may be any form of matter suitable to be transferred through the reactor or vessels as herein described. The slurry may be a fluid or a semiliquid mixture, such as a suspension of solids in a liquid. The slurry may be an aqueous solution or suspension.

As used herein, “CIL” refers to Carbon in Leach. As used herein, ‘CIP” refers to Carbon in Pulp.

Unless specified otherwise, the unit “atm” refers to the gauge pressure.

It is contemplated that the processes, methods, and reactors herein described may be used for any suitable pressure oxidative process, such as those limited by organic carbon preg-robbing material in the feed ore.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and are intended to be included within the scope of the following claims.

1. A process for removing organic carbon material from an ore or concentrate comprising precious metal and organic carbon material, the process comprising:
receiving the ore or concentrate; and
hydrometallurgically treating the ore or concentrate in the presence of oxygen at a temperature and a pressure sufficient to oxidize at least a portion of the organic carbon material.

2. The process of claim 1, wherein treating the ore or concentrate occurs in a pressure vessel.

3. The process of claim 2, wherein treating the ore or concentrate in a pressure vessel comprises treating the ore or concentrate in a pipe reactor.

4. The process of any one of claims 1 to 3, further comprising pre-treating the ore or concentrate in a pressure oxidation autoclave.

5. The process of claim 4, wherein the pressure oxidation autoclave treatment occurs at a temperature of about 180 to about 270 degrees Celsius, or about 180 to about 245 degrees Celsius, or about 180 to about 240 degrees Celsius.

6. The process of claim 4 or 5, wherein the pressure oxidation autoclave treatment occurs at a pressure of about 10 to about 60 atm, about 13 to about 57 atm, about 13 to about 50.

7. The process of any one of claims 1 to 6, wherein receiving the ore or concentrate comprises receiving a pre-treated slurry of the ore or concentrate.

8. The process of claim 7, wherein treating the ore or concentrate comprises:
heating the slurry;
transferring the slurry through a pipe reactor;
adding oxygen to the slurry in the pipe reactor;
maintaining the slurry, for a select duration, at the temperature and the pressure sufficient to oxidize at least a portion of the organic carbon material;
cooling the slurry; and
depressurizing the slurry.

9. The process of any one of claims 1 to 8, wherein the slurry is heated to a temperature of about 250 to about 320 degrees Celsius, or about 250 to about 300 degrees Celsius, or about 270 to about 320 degrees Celsius, or about 270 to about 300° C. to oxidize at least a portion of the organic carbon material.

10. The process of any one of claims 1 to 9, wherein the slurry is pressurized to a pressure of about 50 to about 107 atm, or about 50 to about 120 atm, or about 58 to about 120 atm to oxidize at least a portion of the organic carbon material.

11. The process of any one of claims 1 to 10, wherein the select duration is about 5 to about 30 min, or about 5 min to about 45 min, or about 5 min to about 60 min.

12. The process of any one of claims 1 to 11 further comprising recovering at least a portion of the precious metal from the ore or concentrate after oxidizing at least a portion of the organic material.

13. The process of claim 12, wherein recovering the portion of the precious metal comprises a precipitation process or an adsorption process.

14. The process of claim 13, wherein the adsorption process comprises adsorption of the precious metal onto activated carbon or a resin.

15. The process of claim 14, wherein treating the ore or concentrate increases the affinity of the precious metal to the activated carbon or resin.

16. The process of any one of claims 1 to 15, wherein the precious metal is gold and/or silver.

17. The process of any one of claims 1 to 16, wherein the ore or concentrate further comprises sulfide minerals, sulfur, inorganic carbon, or any combination thereof.

18. The process of claim 17, comprising oxidizing at least a portion of the sulfide minerals and/or sulfur in the treating or pre-treatment step.

19. A reactor system for removing organic carbon material from an ore or concentrate comprising precious metal and organic carbon material, the reactor system comprising:
an inlet for receiving an untreated or pre-treated slurry of the ore or concentrate;
a vessel having a first end with the inlet, an oxygen injector, and a degasser;
a pressurizer for controlling the pressure of the slurry in the vessel;
a heater for elevating the temperature of the slurry in the vessel to a temperature sufficient to oxidize at least a portion of the organic carbon material; and
an outlet at a second end of the vessel, the outlet for providing the treated slurry for further processing.

20. The reactor system of claim 19 further comprising a pump for transferring the slurry through the vessel.

21. The reactor system of claim 19 or 20, further comprising a pre-heating apparatus, wherein the inlet is connected to the pre-heating apparatus for pre-heating the slurry prior to receiving the slurry at the inlet.

22. The reactor system of any one of claims 19 to 21, further comprising a cooling apparatus, wherein the outlet is coupled to the cooling apparatus for cooling the treated slurry after exiting the outlet.

23. The reactor system of any one of claims 19 to 22, further comprising a heat exchanger to transfer heat from the treated slurry to the untreated or pre-treated slurry.

24. The reactor system of any one of claims 19 to 23, further comprising a flash vessel and wherein the outlet is coupled to the flash vessel for depressurizing the treated slurry.

25. The reactor system of any one of claims 19 to 24, wherein the vessel is a pipe.

26. The reactor system of any one of claim 25, wherein the pipe has a length that is greater than ten times the diameter of the pipe.

27. The reactor system of claim 26, wherein the length of the pipe is about 500 to about 1,000 m, or about 500 to about 3000 m.

28. The reactor system of claim 26 or 27, wherein the length of the pipe extends in a winding arrangement to reduce the footprint of the hybrid pipe reactor.

29. A method of increasing recovery of precious metal from an ore or concentrate containing precious metal, sulfide minerals, and organic carbon material, the method comprising hydrometallurgical treatment of the ore or concentrate using an elevated temperature and pressure hybrid pipe reactor, in the presence of oxygen, to increase precious metal recovery.

30. A hybrid reactor system for recovering precious metal from an ore or concentrate comprising precious metal and organic carbon material, the system comprising:
an autoclave for pre-treating a slurry of the ore or concentrate;
a pipe reactor for treating the pre-treated slurry at elevated temperature and pressure in the presence of oxygen to oxidize at least a portion of the organic carbon material; and
a recovery system for precipitating or adsorbing the precious metal from the treated slurry.

31. The hybrid reactor system of claim 30, further comprising a pressurizer downstream of the pipe reactor for maintaining or controlling backpressure in the pipe reactor.

32. The hybrid reactor system of claim 30 or 31, further comprising a flash vessel for depressurizing the treated slurry exiting the pipe reactor.

33. The hybrid reactor system of any one of claims 30 to 32, further comprising a pre-heating system for increasing the temperature of the pre-treated slurry exiting the autoclave.

34. The hybrid reactor system of any one of claims 30 to 33, further comprising a pressurizer for increasing the pressure of the pre-treated slurry exiting the autoclave.

35. The hybrid reactor system of any one of claims 30 to 34, further comprising a subcooling system for decreasing the temperature of the treated slurry exiting the pipe reactor.

36. The hybrid reactor system of claim 35, wherein the pre-heating system and the subcooling system are directly or indirectly coupled to transfer heat from the treated slurry exiting the pipe reactor to the pre-treated slurry exiting the autoclave.

37. The hybrid reactor system of any one of claims 30 to 36, wherein the pipe reactor comprises the reactor of any one of claims 19 to 28.
